(19) United States
(12) Patent Application Publication
(10) Pub. No.: US 2011/0212879 A1
(43) Pub. Date: Sep. 1, 2011

(54) CONCENTRATED SHAMPOO

(76) Inventor: Timothy John Madden, Wirral (GB)

(21) Appl. No.: 13/127,100

(22) PCT Filed: Sep. 28, 2009
(86) PCT No.: PCT/EP2009/062550

§ 371 Date: May 2, 2011

(30) Foreign Application Priority Data
Nov. 7, 2008 (EP) 08168601.6

(51) Int. Cl. C11D 3/60

(52) U.S. Cl. 510/463; 510/495; 510/490; 510/496

(57) ABSTRACT

Concentrated shampoo composition comprising from 25 to 38% wt. C10-C14 ether sulphate as cleansing surfactant, from 0.5 to 5% salt and wherein the zero shear viscosity of the composition is from 2 to 2000 Pa·s and the composition comprises 90% vol. or more composition in the nematic discotic phase.

The present invention relates to a concentrated shampoo.
WO 94/16680 discloses concentrated personal wash compositions.
US 2005/043194 discloses single phase dilution thickening compositions.
US 2003/134760 discloses clear shampoo compositions.
EP-A-1 250 938 discloses water-soluble home care concentrated compositions.
US 2003/215479 discloses a process for manufacturing hair cosmetic or skin cosmetic products.
WO 01/25378 discloses structured surfactant systems.

Despite the prior art there remains the need for improved concentrated shampoo compositions.

Accordingly, there is provided a concentrated shampoo composition according to claim 1.

The majority of the composition of the invention lies in a nematic discotic phase in a phase diagram. A nematic discotic phase is a standard term in the art and denotes phase which is easily identified in NMR imaging whereby non axially aligned discs can easily be distinguished.

The phase behaviour of a typical shampoo composition is such that a regular, non-concentrated shampoo composition will be in the isotropic phase. Typically, at higher surfactant concentration a hexagonal phase will exist however this provides a composition which is too viscous to be suitable for the typical consumer. At yet higher surfactant concentrations a lamellar phase will exist however this is not able to deliver actives as well as the isotropic phase. So, normally the formulator has little difficulty with phase diagrams when formulating a standard non-concentrated shampoo. The rheology of these compositions is typically controlled with salt to increase the size of the surfactant micelles. In other words, salt is used to thicken compositions. To a composition in the hexagonal phase, salt would push them further along the phase diagram into the lamellar phase. However, lamellar phase compositions are not suitable for shampoo compositions since they are poor at depositing materials such as silicones. Accordingly, it is surprising that it is possible to have a composition which behaves like an isotropic composition insofar as it has the right rheology and deposits materials such as silicones, without being in the hexagonal or lamellar phases.

We have surprisingly found that adding salt to compositions which would ordinarily be in the hexagonal phase do not in fact become even thicker, but, instead, become thinner. The resultant compositions are in a nematic discotic phase.

In other words, addition of salt to a concentrated composition provides a window of nematic discotic phase which provides similar rheologies to compositions in the isotropic phase.

Preferably, the zero shear viscosity is from 10 to 200 Pa·s.

Preferably, the composition comprises 95% vol. or more, preferably 99% or more composition in the nematic discotic phase.

The composition may comprise any single or mixture of surfactants commonly used in shampoo compositions. Preferably, the surfactant is selected from anionic, non-ionic and zwitterionic and mixtures thereof. Preferably, the cleansing surfactant is anionic surfactant.

The level of surfactant present in the concentrated shampoo correlates with the concentrated intent and is typically two or three times higher than that found in regular, unconcentrated shampoos.

Preferably, the cleansing surfactant is present at from 30 to 37% wt.

In a preferred embodiment the cleansing surfactant comprises C10-C14 alkyl ether sulphate, more preferably sodium lauryl ether sulphate. More preferably, the sodium lauryl ether sulphate comprises an average EO number of from 1 to 3 and is most preferably from 1 to 1.4.

The concentrated shampoo may also comprise a co-surfactant. Preferred co-surfactants are the amphoteric surfactants. More preferably, the co-surfactant is cocoamidopropyl betaine or cocamide MEA.

Preferably, the co-surfactant is present at from 0.5 to 5% wt. of the composition, more preferably from 1 to 3% and most preferably from 1.5 to 2.5% wt. of the composition.

Preferably, the composition comprises anionic surfactant and co-surfactant in a wt. ratio of from 10:1 to 17:1, more preferably from 12:1 to 16:1 and most preferably from 13:1 to 15:1.

Preferably, the salt is a sodium salt and more preferably it is selected from sodium chloride and sodium sulphate.

Where the salt is sodium chloride it is preferred that it is present at from 1 to 3% wt. of the composition.

Where the salt is sodium sulphate it is preferred that it is present at from 2 to 4% wt. of the composition.

Preferably, the concentrated shampoo comprises an oil. The change in phase structure effected by the salt enables the concentrated shampoo composition to carry materials that would not be possible outside the nematic discotic phase. Suitable materials include oils.

Preferably, the oil is selected from mineral oil, vegetable oil, animal oil, or mixtures thereof and more preferably mineral oil.

Preferably, the concentrated shampoo may comprise an oil is selected from coconut oil and palm kernel oil.

The shampoo according to the invention may comprise any materials commonly found in shampoo compositions such as thickeners, pearlescers, silicones, fatty materials, colourants, perfumes, etc.

### EXAMPLE 1

The following are formulations made by standard processes.

| | | | % Active |
|---|---|---|---|
| | % Active | % wt. | in material |
| Sodium Laureth Sulphate | 35 | 50 | 70% |
| Cocamide MEA | 2.5 | 2.5 | 100% |
| Dimethiconol/TEA-DOBS | 5 | 10 | 50% |
| Sodium chloride | 1 | 1 | 100% |
| Parfum | 1 | 1 | 100% |
| Guar Hydroxypropyl | 0.2 | 0.2 | 100% |
| Trimonium Chloride | | | |
| DMDM Hydantoin and 3-iodo- | 0.2 | 0.4 | 50% |
| 2propylnylbutyl carbamate | | | |
| Aqua | q.s. to 100 | q.s. to 100 | 100% |

| | | | % Active |
|---|---|---|---|
| | % Active | % wt. | in material |
| Sodium Laureth Sulphate | 35 | 50 | 70% |
| Cocamide MEA | 2.5 | 2.5 | 100% |
| Dimethiconol/TEA-DOBS | 5 | 10 | 50% |
| Sodium chloride | 1 | 1 | 100% |
| ML40 | 1 | 1 | 100% |
| Parfum | 1 | 1 | 100% |
| Guar Hydroxypropyl | 0.2 | 0.2 | 100% |
| Trimonium Chloride | | | |
| DMDM Hydantoin and 3-iodo- | 0.2 | 0.4 | 50% |
| 2propylnylbutyl carbamate | | | |
| Aqua | q.s. to 100 | q.s. to 100 | 100% |

### EXAMPLE 2

### Sodium Chloride

| | | | | | | | | | |
|---|---|---|---|---|---|---|---|---|---|
| % SLES | 14 | 21 | 24.5 | 28 | 31.5 | 35 | 38.5 | 42 | 49 |
| % CMEA | 1 | 1.5 | 1.75 | 2 | 2.25 | 2.5 | 2.75 | 3 | 3.5 |
| total | 15 | 22.5 | 26.25 | 30 | 33.25 | 37.5 | 41.25 | 45 | 52.5 |
| D | L1 | L1 | L1 | ND | ND | ND | La | La | La |
| C | L1 | L1 | L1 | L1 | ND | ND | ND | ND | La |
| B | L1 | L1 | L1 | L1 | ND | ND | ND | H1 | La |
| A | L1 | L1 | L1 | L1/H1 | H1 | H1 | H1 | H1 | H1 |

A 0% NaCl
B 0.5% NaCl
C 1% NaCl
D 2% NaCl
L1 Isotropic phase
ND Nematic discotic phase
La Lamellar phase
H1 Hexagonal phase

### Sodium Sulphate

| | | | | | | | | | |
|---|---|---|---|---|---|---|---|---|---|
| % SLES | 14 | 21 | 24.5 | 28 | 31.5 | 35 | 38.5 | 42 | 49 |
| % CMEA | 1 | 1.5 | 1.75 | 2 | 2.25 | 2.5 | 2.75 | 3 | 3.5 |
| total | 15 | 22.5 | 26.25 | 30 | 33.25 | 37.5 | 41.25 | 45 | 52.5 |
| E | L1 | L1 | L1 | L1 | L1 | ND | ND | La | La |
| D | L1 | L1 | L1 | L1 | ND | ND | ND | H1/ | La |
| | | | | | | | | La | |
| C | L1 | L1 | L1 | ND | H1/ | H1 | H1/ | H1/ | La |
| | | | | | ND | | ND | ND | |
| B | L1 | L1 | ND | H1/ | H1/ | H1 | H1/ | H1 | H1/ |
| | | | | ND | ND | | ND | | La |
| A | L1 | L1 | L1 | L1/ | H1 | H1 | H1 | H1 | H1 |
| | | | | H1 | | | | | |

A 0% Na sulphate
B 1% Na sulphate
C 2% Na sulphate
D 3% Na sulphate
E 4% Na sulphate

### Mineral Oil

| | | | | | | | | | |
|---|---|---|---|---|---|---|---|---|---|
| % SLES | 14 | 21 | 24.5 | 28 | 31.5 | 35 | 38.5 | 42 | 49 |
| % CMEA | 1 | 1.5 | 1.75 | 2 | 2.25 | 2.5 | 2.75 | 3 | 3.5 |
| total | 15 | 22.5 | 26.25 | 30 | 33.25 | 37.5 | 41.25 | 45 | 52.5 |
| E | | | L1 | L1 | L1/H1 | H1 | H1 | H1 | H1 |
| D | | | L1 | L1 | Multi | H1 | H1 | H1 | H1 |
| C | L1 | L1 | L1 | Multi | L1/H1 | H1 | H1 | H1 | H1 |
| B | L1 | L1 | L1 | L1/H1 | H1 | H1 | H1 | H1 | H1 |
| A | L1 | L1 | L1 | L1/H1 | H1 | H1 | H1 | H1 | H1 |

A 0% mineral oil
B 1% mineral oil
C 2% mineral oil
D 3% mineral oil
E 4% mineral oil

### Combinations

| | | | | | | | | | |
|---|---|---|---|---|---|---|---|---|---|
| % SLES | 14 | 21 | 24.5 | 28 | 31.5 | 35 | 38.5 | 42 | 49 |
| % CMEA | 1 | 1.5 | 1.75 | 2 | 2.25 | 2.5 | 2.75 | 3 | 3.5 |
| total | 15 | 22.5 | 26.25 | 30 | 33.25 | 37.5 | 41.25 | 45 | 52.5 |
| B | L1 | L1 | L1 | L1/ | H1/ | ND | ND | H1/ | La |
| | | | | ND | ND | | | La | |
| A | L1 | L1 | L1 | L1/ | H1 | H1 | H1 | H1 | H1 |
| | | | | H1 | | | | | |

A 0% NaCl and 1% mineral oil
B 1% NaCl and 1% mineral oil

### EXAMPLE 3

### Method for Preparation of Small Samples, Ascertaining Ratio of Multiple Phase if Present and Identifying Phase Structures

Formulations were prepared in 5 g batches, all the ingredients were added to a 20 ml crimp top glass GC vial, stoppered with butyl rubber bung and crimped closed with aluminium crimp. They were then heated for 3-4 hours or overnight in an oven at 85° C. The samples were allowed to cool, unsealed, mixed, resealed and heated again to 85° C. for 3-4 hours or overnight. This cycle was repeated until the sample was homogeneous or there was no change on reheating. Once cooled the samples in vials were visually assessed to identify if the samples had separated into two or more layers indicating multiple phases present. The ratio of the amounts of the phases present can be obtained by measuring the vertical distance each phase occupies in the vial. The cooled samples were examined by polarising optical microscopy, Olympus BX51 with 10× objective, using the observed textures to identify the resulting surfactant phases (S. Hassan, W. Rowe & GJT. Tiddy, Handbook of Applied Surfactant and Colloid Chemistry Vol. 1, p 465). If multiple phases were present a sample of material from each phase was extracted and examined individually.

### Method for Measuring Zero Shear Viscosity

Rheology of shampoos was measured with a TA Instruments ARG2 Control Stress Rheometer at 25° C. The zero shear viscosity value was taken to be the measured shear viscosity at the shampoo's yield stress. The yield stress was identified from a strain frequency sweep.

1. Concentrated shampoo composition comprising from 25 to 38% wt. C10-C14 ether sulphate as cleansing surfactant, from 0.5 to 5% salt and wherein the zero shear viscosity of the composition is from 2 to 2000 Pa·s and the composition comprises 90% vol. or more composition in the nematic discotic phase.

2. Composition according to claim 1 wherein the zero shear viscosity is from 10 to 200 Pa·s.

3. Composition according to claim 1 or 2 comprising 95% vol. or more composition in the nematic discotic phase.

4. Shampoo composition according to any preceding claim wherein the salt is a sodium salt.

5. Shampoo composition according to any preceding claim wherein the salt is selected from sodium chloride and sodium sulphate.

6. Shampoo composition according to claim 6 wherein the salt is sodium chloride and is present at from 1 to 3% wt. of the composition.

7. Shampoo composition according to claim 6 wherein the salt is sodium sulphate and is present at from 2 to 4% wt. of the composition.

8. Shampoo composition according to any preceding claim further comprising an oil.

9. Shampoo composition according to claim 9 wherein the oil is selected from mineral oil, vegetable oil, animal oil, or mixtures thereof.

10. Shampoo composition according to claim 9 wherein the oil is selected from coconut oil and palm kernel oil.

11. Shampoo composition according to any preceding claim wherein the cleansing surfactant is anionic surfactant.

12. Shampoo composition according to any preceding claim wherein the cleansing surfactant is present at from 30 to 37% wt.

13. Shampoo composition according to any preceding claim wherein the composition comprises from 0.5 to 5% wt. co-surfactant.

14. Shampoo composition according to any preceding claim wherein the cleansing surfactant comprises sodium lauryl ether sulphate.

15. Shampoo composition according to any preceding claim wherein the composition comprises cocoamidopropyl betaine or cocamide MEA.
